(19) United States
(12) Patent Application Publication
(10) Pub. No.: US 2018/0365871 A1
(43) Pub. Date: Dec. 20, 2018

(54) COMMUNICATION BETWEEN VISUAL REPRESENTATIONS

(71) Applicant: General Electric Company, Schenectady, NY (US)

(72) Inventors: Jaime NAHMAN, San Ramon, CA (US); Benoit CHEVALIER, San Ramon, CA (US)

(21) Appl. No.: 15/624,831

(22) Filed: Jun. 16, 2017

(51) Int. Cl. G06T 11/20; G06F 17/21; G06F 17/30; G06F 9/48

(52) U.S. Cl. CPC G06T 11/206; G06F 17/212; G06F 17/30905; G06F 9/4881; G06F 17/3089

(57) ABSTRACT

The example embodiments are directed to a system and method for managing communications between visual representations. In one example, the method includes receiving a processing request of a first visual representation displayed on a web page, wherein the processing request includes a request to identify underlying data used to generate a portion of the first visual representation, scheduling the processing request to be performed by a web worker from among a plurality of web workers included in a background, receiving a processing result of the processing request from the at least one web worker, the processing result including an identification of the underlying data of the portion of the first visual representation, and transferring the identification of the underlying data of the portion of the first visual representation to a second visual representation.

### BACKGROUND

Machine and equipment assets, generally, are engineered to perform particular tasks as part of a business process. For example, assets can include, among other things and without limitation, industrial manufacturing equipment on a production line, drilling equipment for use in mining operations, wind turbines that generate electricity on a wind farm, transportation vehicles such as trains and aircraft, and the like. As another example, assets may include devices that aid in diagnosing patients such as imaging devices (e.g., X-ray or MM systems), monitoring equipment, and the like. The design and implementation of these assets often takes into account both the physics of the task at hand, as well as the environment in which such assets are configured to operate.

Low-level software and hardware-based controllers have long been used to drive machine and equipment assets. However, the rise of inexpensive cloud computing, increasing sensor capabilities, and decreasing sensor costs, as well as the proliferation of mobile technologies have created opportunities for creating novel industrial and healthcare based assets with improved sensing technology and which are capable of transmitting data that can then be distributed throughout a network. As a consequence, there are new opportunities to enhance the business value of some assets through the use of novel industrial-focused hardware and software.

Raw data captured and analyzed from an asset is not very user-friendly and often includes multiple components and variables. In order to visualize data in a more convenient manner, visual representations are often provided based on data variables and can include various types of charts, diagrams, graphs, and the like. When displayed via a network such as the Internet, a visual representation can consume a significant amount of web/network resources thus diminishing a processing speed of a system processing a display of the visual representation. Furthermore, when multiple visual representations are displayed via the same web page, at the same time, the processing speed of the system is even further reduced. Therefore, what is needed is system and method capable of efficiently processing visual processing requests from a visual representation.

### SUMMARY

Embodiments described herein improve upon the prior art by providing systems and methods which enable visual representations displayed via web page to communicate efficiently. As described herein, a visual representation may include a chart, a line, a graph, or the like, having a plurality of data points that are related to one another using variables. When a user moves a cursor to hover over one portion of data included in a first visual representation, the system is capable of highlighting a corresponding portion of a second visual representation that corresponds to the same or related data. Here, the second visual representation may be a different type of chart or graph than the first visual representation but represent the same or related data received from, for example, an asset or other machine or equipment. In some embodiments, the system may include a scheduler and a plurality of web workers which are capable of handling processing requests received from the visual representations and splitting the requests between web workers and a main processing thread of the web page thereby relieving the main thread from having to handle every visual processing request from the web page. As a result, the visual processing of the representations displayed via the web page may be processed significantly faster without any lag creating a seamless and more user friendly viewing of the data. In some examples, the embodiments herein may be incorporated within software that is deployed on a cloud platform for use with an Industrial Internet of Things (IIoT) system.

In an aspect of an example embodiment, a computer-implemented method includes receiving a visual processing request of a first visual representation displayed on a web page, wherein the visual processing request includes a request to identify underlying data used to generate a portion of the first visual representation, scheduling the visual processing request to be performed by a web worker from among a plurality of web workers included in a background, receiving a visual processing result of the request from the at least one web worker, the visual processing result including an identification of the underlying data of the portion of the first visual representation, and transferring the identification of the underlying data of the portion of the first visual representation to a second visual representation.

In an aspect of another example embodiment, a computing system includes a memory storing instructions, and a processor configured to execute the instructions, wherein the executed instructions cause the processor to receive a visual processing request of a first visual representation displayed on a web page, wherein the visual processing request includes a request to identify underlying data used to generate a portion of the first visual representation, schedule the visual processing request to be performed by a web worker from among a plurality of web workers included in a background, receive a visual processing result of the request from the at least one web worker, the visual processing result including an identification of the underlying data of the portion of the first visual representation, and transfer the identification of the underlying data of the portion of the first visual representation to a second visual representation or transfer it back to the first visual representation for the first visual representation to broadcast the result to whichever other visual representation needs it.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a cloud computing environment for processing communications from visual representations in accordance with an example embodiment.

FIG. 2 is a diagram illustrating an example of a second visual representation being highlighted based on a user action with a first visual representation in accordance with an example embodiment.

FIG. 3 is a diagram illustrating a process of restructuring web page data in accordance with an example embodiment.

FIG. 4 is a diagram illustrating components of a web page processing requests from visual representations in accordance with an example embodiment.

FIG. 5 is a diagram illustrating a method for processing communications from visual representations in accordance with an example embodiment.

FIG. 6 is a diagram illustrating a computing system for processing communications from visual representations in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

As described herein, visual representations such as charts, tables, graphs, lines, and the like, are based on data points associated with data that may be sensed by and received from an asset such as a machine or equipment included in an Industrial Internet of Things (IIoT). Examples of assets include a wind turbine, a locomotive, a jet engine, a printing press, an oil rig, and the like. A visual representation can be used to provide a user-friendly view of the data that quickly provides a user with knowledge of the underlying data that is used to generate the visual representation. Often, a user will be viewing data using different visual representations. Specific examples of visual representations include, but are not limited to, a time-series graph, a radar chart, a pie/donut chart, a polar chart, a time-series plot, an XY line scatter, a parallel coordinates, and the like. Different types of charts may be included within a chart framework that also includes the communication technology described herein.

When a user moves a cursor to hover over one portion of data included in a first visual representation, the example embodiments provide a system and a software that is capable of highlighting a corresponding portion of a second visual representation that corresponds to the same or related data. Here, the second visual representation may be a different type of chart or graph than the first visual representation but represent either the same data or different data that is related data. For example, the related data may be linked by a common dimension (variable) such as time. The data may be received from, for example, an asset or other machine or equipment. As a non-limiting example, a first chart could represent a variable of pressure versus time received from an asset, while a second chart could represent a variable of temperature versus time received from the asset. Here, the two charts may be linked to each other via a common dimension between the two charts (i.e., time) while also having a different dimension (pressure and temperature).

Rather than execute all processing requests on a main thread of the web pages, the embodiments may schedule various visual processing requests for processing by one or more web workers associated with particular visual representations. For example, the software may include a scheduler capable of handling processing requests received from the visual representations and splitting the requests between web workers (e.g., threads) which are in a background of a main processing thread of the web page thereby relieving the main thread from having to handle all visual processing requests from the web page. As a result, the visual processing of the representations displayed via the web page may be processed significantly faster without lag creating a user friendly viewing experience.

The visual communication system and software described herein may be deployed within a cloud platform computing environment, for example, an Internet of Things (IoT) or an Industrial Internet of Things (IIoT) platform. While progress with machine and equipment automation has been made over the last several decades, and assets have become ‘smarter,’ the intelligence of any individual asset pales in comparison to intelligence that can be gained when multiple smart devices are connected together, for example, in the cloud. Assets, as described herein, may refer to equipment and machines used in fields such as energy, healthcare, transportation, heavy manufacturing, chemical production, printing and publishing, electronics, textiles, and the like. Aggregating data collected from or about multiple assets can enable users to improve business processes, for example by improving effectiveness of asset maintenance or improving operational performance if appropriate industrial-specific data collection and modeling technology is developed and applied.

Sensed data from or about assets is often time-series data. The time series data may include one or more variables such as speed, temperature, velocity, movement, pressure, humidity, etc., measured over time. The received/sensed time series data may include time stamps associated with each reading, measurement, etc. Accordingly, the received data may be plotted on a visual representation as data points based on the time stamps and visually linked to each other within the visual representation via a line, curve, drawing, or other visual cue or mechanism. The linked data may be used to provide a user-friendly means of displaying results of the sensed data from the asset.

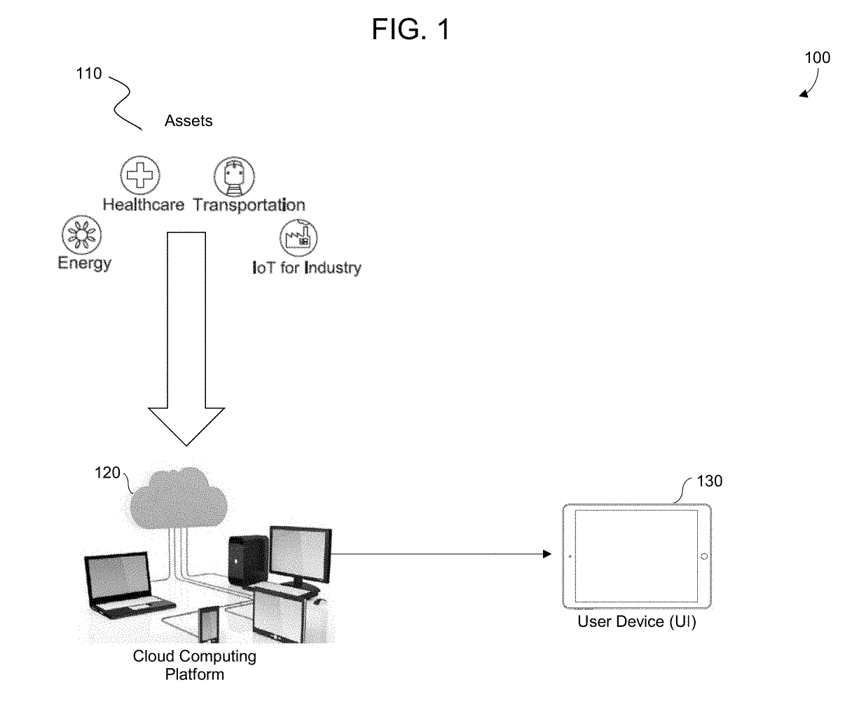

FIG. 1 illustrates a cloud-based system 100 for processing communications between visual representations in accordance with an example embodiment. Referring to FIG. 1, the system 100 includes a group of assets 110, a cloud computing platform 120 (e.g., cloud platform) that represents a cloud-based environment according to various embodiments, and a user device 130. Here, the assets 110, the cloud computing platform 120, and the user device 130 may be connected via a network or group of networks such as a public network (e.g., Internet), a private network, and the like. It should be appreciated that the system 100 is merely an example and may include additional devices and/or one of the devices shown may be omitted. The visual representation processing software described herein may be a program or other type of software deployed on the cloud computing platform 120, or in another device. The cloud computing platform 120 may be one or more of a server (e.g., a web server), a computer, a database, and the like, included in a cloud-based platform. The user device 130 may include a computer, a laptop, a tablet, a mobile device, a television, an appliance, a kiosk, and the like.

An asset 110 may be outfitted with one or more sensors configured to monitor respective operations or conditions of the asset 110, its components, and its surrounding environment. Data from the sensors can be recorded and/or transmitted to the cloud computing platform 120 where it can be accessed by applications executing within the cloud and user devices such as user device 130 accessing the cloud. By bringing such data into a cloud-based system 100, analytics may be executed on the data. Insights gained through analysis of such data can lead to enhanced asset designs, enhanced software algorithms for operating the same or similar assets, better operating efficiency, and the like. In addition, analytics may be used to analyze, evaluate, and further understand issues related to operation of the asset within manufacturing and/or industry. In order to represent the raw sensed data (in raw form, processed form, analyzed form, etc.) one or more visual representations may be generated. The visual representations may be based on a plurality of data points that are plotted based on X and Y coordinates where the X axis and the Y axis represent variables such as time, velocity, temperature, etc.

According to various embodiments, data from assets 110 may be analyzed by one or more visual processing applications executing on the cloud platform 120 including user interfaces, renderers, and the like, capable of displaying the data in graphical form such as via charts, diagrams, tables, and the like. The software described herein may be a program or other code module included within a software application, included within a web page, or the like. The user device 130 may have a screen that displays the user interface generated by the applications executing on the cloud platform 120.

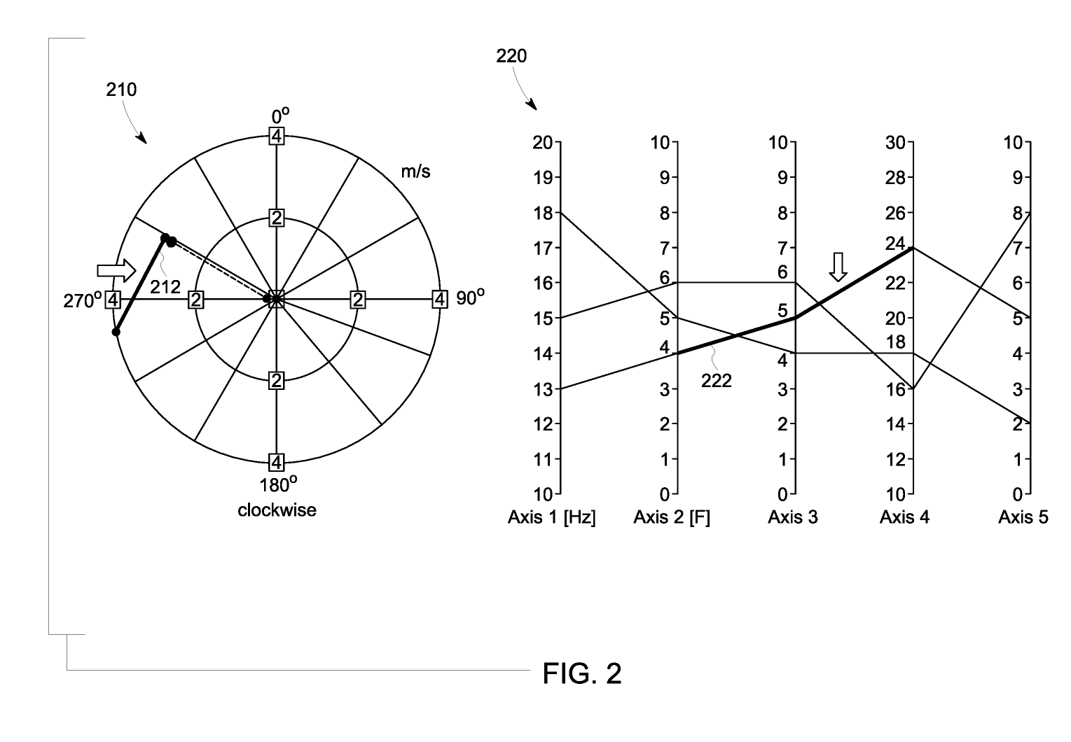

FIG. 2 illustrates an example of different visual representations that may be displayed via the user interface of the user device 130. Here, the visual representations may correspond to web content displayed via web page. Typically, the more visual representations displayed on a web page, the slower the processing speed of the page. As shown in FIG. 2, a first visual representation 210 includes a polar coordinates chart while a second visual representation 220 includes a parallel coordinate chart. In this example, both the first visual representation 210 and the second visual representation 220 are generated based on the related underlying data which may be time-series data acquired from or associated with one or several assets such as a machine or equipment used in industry or manufacturing. However, it should be appreciated that the types of visual representations that may be used are not limited to the types shown in FIG. 2. When a user moves a cursor over a portion 212 of the first visual representation 210, the software described herein may automatically highlight a portion 222 of the second visual representation 220 based on the underlying data associated with the portion 212 of the first visual representation 210. In this example, a display of the portion 212 of the first visual representation 210 is generated based on some related underlying time-series data that is used to generate a display of the portion 222 of the second visual representation 220.

However, in order to identify the underlying data from the first visual representation 210 and transfer an identification of the underlying data to the second visual representation 220, a computationally intensive search process must be performed to identify a location of the cursor with respect to the data points in the visual representation 210. Accordingly, rather than require the web page (or a main thread thereof) to process the search process, the web page can utilize one or more web workers in a background. For example, a web worker may be a thread (e.g., JavaScript thread) that is separate and distinct from a main processing thread of the web page. The web worker is a means for web content to run scripts in background threads. A web worker thread can perform tasks without interfering with the user interface displaying the visual representations. In addition, a web worker can perform I/O using XML Http Request. Once created, a web worker can send messages to the JavaScript code that created it by posting messages to an event handler specified by that code, and vice versa. For example, the web worker may be an object created using a constructor that runs a named JavaScript file that contains the code that will run in the worker thread. Web workers may run in another global context that is different from the current window.

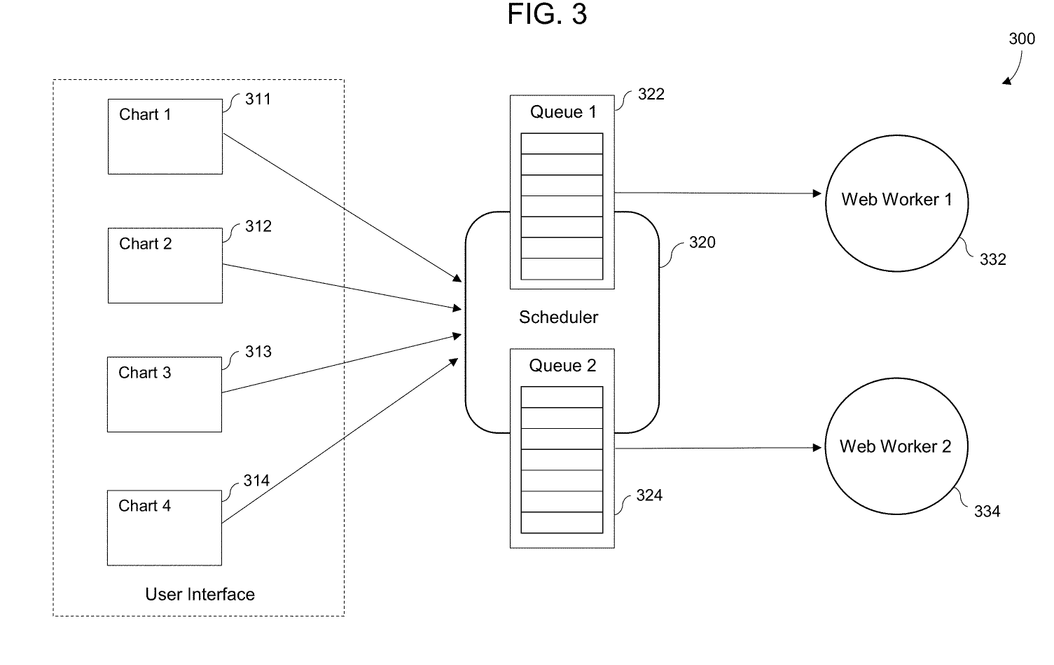

FIG. 3 illustrates a web page 300 processing communication requests from visual representations in accordance with an example embodiment. Referring to FIG. 3, the web page 300 includes a user interface layer which may be displayed on a screen of a display such as an embedded display of a user device or an external display connected to the user device. Here, the user interface includes a plurality of charts 311-314 that are web content generated based on the same or related underlying data but which may be different chart/graph types. Examples of chart types include polar charts, radar charts, time-series charts, scatter plots, parallel coordinates, pie charts, line charts, bar charts, and the like. The web page 300 also includes a plurality of web workers 332 and 334 capable of processing requests from the charts 311-314. Although not shown in FIG. 3, the web page also includes at least one main thread for processing various process requests of the web content of the web page 300.

According to various embodiments, the web page 300 also includes a scheduler 320 for scheduling web content processing requests between the web workers 332 and 334 as well as the main thread. In some embodiments, each web worker may be dedicated to one chart or multiple charts from among the plurality of charts 311-314. Furthermore, the load on each web worker 332 and 334 may be adjusted based on requests received by the scheduler 320 from the plurality of charts 311-314 such that the amount of processing performed by each of the web workers 332 and 334 is balanced. In the example of FIG. 3, web worker 332 is dedicated to processing requests from chart 311 and chart 312, while web worker 334 is dedicated to processing requests from chart 313 and chart 314. The scheduler also includes a queue 322 for buffering processing requests from charts 311 and 312 to be processed by web worker 332 and queue 324 for buffering processing requests from charts 313 and 314 to be processed by web worker 334. The scheduler 320 may queue requests to be processed for the web workers and dequeue requests for the web workers when the web workers become available.

According to various embodiments, when a user hovers a cursor over a first portion of a chart (e.g., one of charts 311-314), the chart can send a processing request to the scheduler 320 requesting a search for the closest point or set of points within a radius around the cursor, or each closest point from a series of points on the chart (these options are configurable). Here, the chart is searching for the closest match. The scheduler 320 may then transfer the processing request to the designated web worker (e.g., one or more of web workers 332 and 334) which then perform a search to identify a closest data point match with a cursor location. The web worker may compare pixel coordinates (X,Y) from the cursor location on the screen to data points shown on the respective chart to identify a data point that is closest to the cursor location. Once the web worker finds a closest match it stores a time stamp associated with this point and sends the time stamp to the scheduler 320 where it can be transferred to other charts 311-314 or transferred back to the original chart which broadcasts or otherwise transmits the time stamp to other charts.

For example, a time stamp of the closest data point may be identified from within a data set such as a table or other group of data stored in association with the visual representation. That is, a data set may be built in such a manner that every data point in the visual representation is linked to a respective time stamp. Each data point may include a group of values that represent an X axis and Y axis point on the chart and a time stamp relative to the point. The data may be pre-processed to put the data into a format for the chart to use. The time stamp may be transferred from the scheduler 320 to one or more of the other charts. For example, identified time stamp may be provided directly or indirectly to at least one other chart from among the charts 311-314. For example, the scheduler 320 may transmit the time stamp directly to one or more other charts instead of or in addition to the chart where the original search and time stamp identification was performed. As another example, the scheduler 320 may provide the time stamp back to the original chart where the search was performed, and the original chart may then broadcast or otherwise transmit the time stamp to one or more other charts that are listening and that are included in the user interface of the web page 300 concurrently (i.e., simultaneously) being shown with the other charts. Based on the time stamp, the next chart can identify a portion thereof that corresponds to the closest data point based on the time stamp.

Searching for the closest data point can be computational intensive. In a most straightforward approach, a search process may compare each point on the chart to a location of the cursor, identify a distance between each point and the cursor, and determine the shortest distance as the closest point. However, this process is very time consuming. To overcome this issue, examples herein may restructure the chart data using a tree structure (e.g., quadtree, binary tree, etc.) and store the restructured data. Here, the restructuring may be performed by a web worker instead of a main thread of the web page. For example, each time a search request is created by one of the charts 311-314 shown in FIG. 3, the scheduler 320 may capture the request and schedule one or more of the web workers 332 and 334 to search for a closest point and pass the point and time stamp thereof back to the chart or to other charts. As a result, the chart just takes care of passing the data to other charts and is not required to process the search through the main thread of the web page.

In this example, user interaction on the user interface triggers a chart to send a request to the scheduler 320. Here, the scheduler 320 receives data from chart and determines which web worker 332 and/or 334 to send request and what to do with the request. The web worker that receives the request performs the processing of the request, and the results are returned to scheduler 320 which in turn provides the results to the initiating chart or another chart. In this case, the web workers do not block the main UI thread such that the web workers do not hinder the display of the UI. If there were no web workers, the chart would have to do the search for the closest point and it would slow down the web page/charts. The page would lag and there would be incongruity in the display.

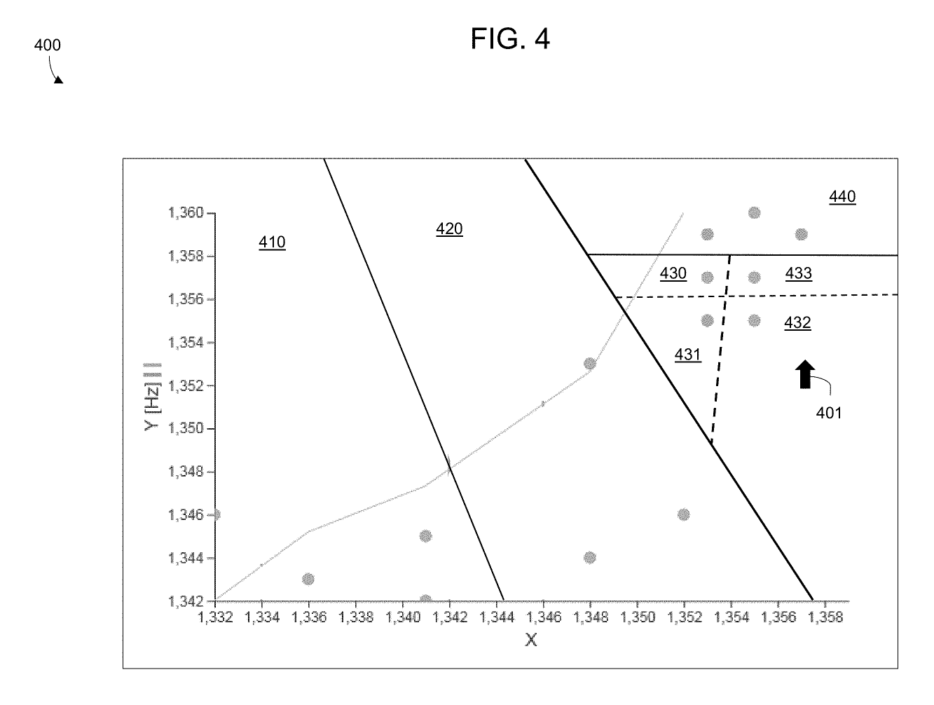

FIG. 4 illustrates a process 400 of restructuring web page data in accordance with an example embodiment. In particular, the process 400 restructures chart data using a quadtree which provides a different way to structure the data and makes it easier to find points geographically on the screen. It should be appreciated that the quadtree restructuring is merely an example, and the embodiments herein are not limited thereto. Referring to FIG. 4, the process 400 takes the whole available space and splits it into four quadrants 410, 420, 430, and 440. For example, the splitting may occur based on the number of data points and not based on total area. Once the first split occurs, the process 400 looks at the available points, and then splits each quadrant in four again. This process continues until there is zero or one points left in a quadrant. As a result, the search process is reduced (in area). Also, because the space is divided based on location of data points and not total area of the screen or the chart, there may be more quadrants in a smaller area, but the processing is more balanced because each quadrant has approximately the same amount of data points. In FIG. 4, the third quadrant 430 is further broken into four sub-quadrants 430, 431, 432, and 433. In this example, the user's cursor is positioned in sub-quadrant 432. Also, the process 400 determines that only one data point remains in the sub-quadrant 432 including the cursor. Accordingly, the search determined that the closes data point is the data point located in quadrant 432.

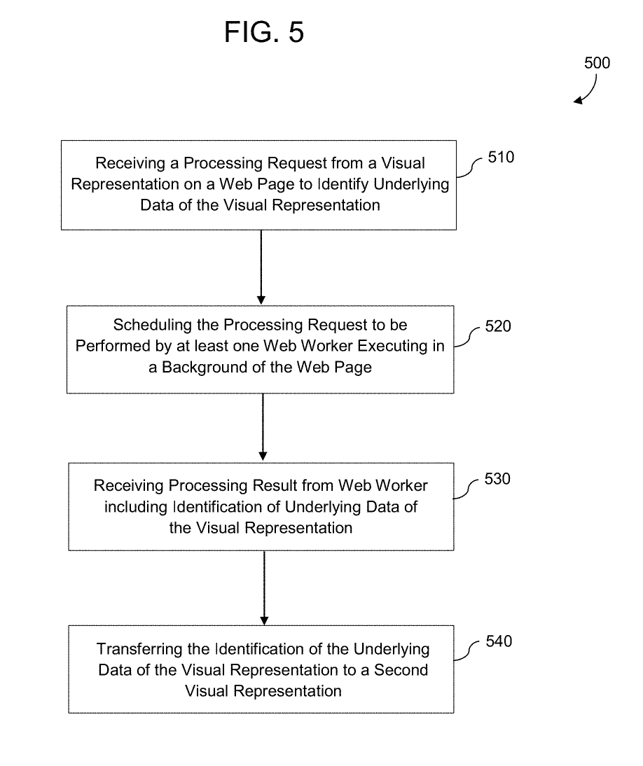

FIG. 5 illustrates a method 500 for processing communications from visual representations in accordance with an example embodiment. For example, the method 500 may be performed by the software and/or the system described herein. The system may include a computing device, a server, a cloud platform, and/or the like. Referring to FIG. 5, in 510, the method includes receiving a processing request from a first visual representation displayed on a web page. Here, the processing request may be received by a scheduler embedded within a web page displaying the visual representation. In this example, the processing request may be generated in response to a user moving a cursor on a screen over a portion of the visual representation such as a chart or diagram shown on the screen causing the portion of the visual representation to be highlighted or otherwise distinguished from other portions of the visual representation on the screen. In response, the visual representation (or the web page) may generate a visual processing request that includes a request to identify underlying time-series data of the highlighted portion of the first visual representation. For example, the request may include a cursor location on the screen including X and Y pixels at which a cursor is located.

In response to receiving the visual processing request, in 520, the scheduler may schedule the processing request to be performed by a web worker from among a plurality of web workers included in a background. For example, the web workers may be threads (e.g., JavaScript threads) that are disposed within a background of the web page and separate from a main processing thread of the web page. A web worker is a means for web content to run scripts in background threads. The worker thread can perform tasks without interfering with a user interface displaying the visual representations. In addition, a web worker can perform I/O using XML Http Request (although the response XML and channel attributes may always be null). Once created, a worker can send messages to the JavaScript code that created it by posting messages to an event handler specified by that code, and vice versa. For example, the web worker may be an object created using a constructor (e.g., Worker( )) that runs a named JavaScript file that contains the code that will run in the worker thread. Web workers may run in another global context that is different from the current window. Thus, using a window shortcut in an attempt to get the current global scope (instead of self) within a Worker will return an error.

In 530, the method further includes receiving a processing result of the processing request from the at least one web worker. The processing result may include an identification of the underlying data of the portion of the first visual representation. For example, the processing request may include a search request to identify a data point of the underlying data that is closest to a current position of a cursor on the screen or some other position on the screen. The web worker may identify the closest data point, from among a plurality of data points included in the first visual representation. Here, the closest data point may be identified based on a quadtree analysis of all data points included in the first visual representation. In some cases, the underlying data of the first visual representation includes time-series data, and the processing result includes an identification of a time stamp of the closest data point of the underlying data of the first visual representation.

In 540, the method further includes transferring the identification of the underlying data of the portion of the first visual representation to a second visual representation. The transferring may be performed either directly or indirectly from the scheduler. For example, the scheduler may receive the identified portion of the underlying data of the first visual representation and transmit the identified portion back to the first visual representation for the first visual representation to broadcast it or otherwise transmit to a second visual representation that is different in type (e.g., polar chart vs. parallel coordinates) than the first visual representation but that is based on the same or related underlying data. As another example, the scheduler may transmit the identified portion of the underlying data directly to one or more other second visual representations. In response to the providing of the identified portion of underlying data from the first visual representation, the web page may highlight a portion of the second visual representation that corresponds to the highlighted portion of the first visual representation, based on the identified data point of the underlying data of the first visual representation. Here, the highlighted data in the second visual representation may be highlighted based on the same underlying data (i.e., in both dimensions/axes) as the first visual representation or related data that is linked by one dimension/axes with respect to the first visual representation.

In some examples, the scheduler may receive and schedule requests from the plurality of visual representations on the screen among the plurality of web workers. Also, the scheduler may continuously monitor a load of the plurality of web workers, and adjust assignments of processing requests among the plurality of web workers to balance the load for the plurality of web workers. Also, although not shown in FIG. 5, the method may further include executing the at least one web worker based on the processing request to obtain the processing result including an identification of the underlying data of the portion of the first visual representation.

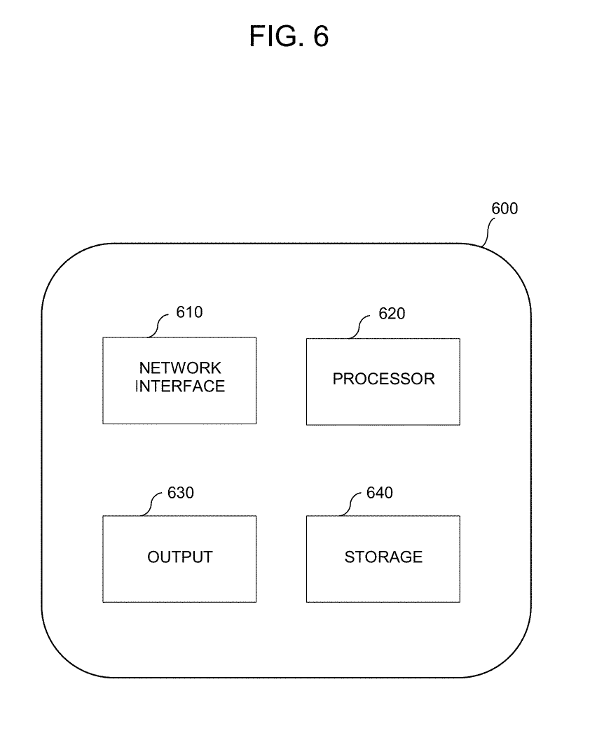

FIG. 6 illustrates a computing system 600 for processing communications from visual representations in accordance with an example embodiment. For example, the computing system 600 may be a device or group of devices included within the cloud computing environment of FIG. 1, or another computing device or group of devices. Also, the computing system 600 may perform the method of FIG. 5. Referring to FIG. 6, the computing system 600 includes a network interface 610, a processor 620, an output 630, and a storage device 640. Although not shown in FIG. 6, the computing system 600 may include other components such as a display, an input unit, a receiver/transmitter, and the like. The network interface 610 may transmit and receive data over a network such as the Internet, a private network, a public network, and the like. The network interface 610 may be a wireless interface, a wired interface, or a combination thereof. The processor 620 may include one or more processing devices each including one or more processing cores. In some examples, the processor 620 is a multicore processor or a plurality of multicore processors. Also, the processor 620 may be fixed or it may be reconfigurable. The output 630 may output data to an embedded display of the computing system 600, an externally connected display, a cloud, another device, and the like. The storage device 640 may store program instructions for execution by the processor 620. The storage device 640 is not limited to any particular storage device and may include any known memory device such as RAM, ROM, hard disk, and the like.

According to various embodiments, the processor 620 may receive a processing request of a first visual representation displayed on a web page. For example, the processing request may include a request to identify underlying data used to generate a portion of the first visual representation. The underlying data may include time series data that is organized by data points on the screen within the visual representation. The visual processing request may include a request to identify a closest point within the visual representation to a predetermined location on the screen. Here, the predetermined location may correspond to a location of a cursor, a highlighted portion of the visual representation, or the like.

In response to receiving the request, the processor 620 may schedule the processing request to be performed by a web worker from among a plurality of web workers included in a background of a web page that is displaying the visual representation. The processor 620 may also control the at least one web worker to execute the visual processing request to generate a processing result of the processing request from the at least one web worker. For example, the processing result may include an identification of the underlying data of the portion of the first visual representation. Here, the identification may include a time stamp of a closest data point to the predetermined location on the screen. The processor 620 may further transfer the identification of the underlying data of the portion of the first visual representation to a second visual representation displayed on the web page.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computer-implemented method comprising:
receiving a processing request of a first visual representation displayed on a web page, wherein the visual processing request includes a request to identify underlying data used to generate a portion of the first visual representation;
scheduling the processing request to be performed by a web worker from among a plurality of web workers included in a background;
receiving a processing result of the processing request from the at least one web worker, the processing result including an identification of the underlying data of the portion of the first visual representation; and
transferring the identification of the underlying data of the portion of the first visual representation to a second visual representation.

2. The computer-implemented method of claim 1, wherein the processing request includes a search request to identify a data point of the underlying data, from among a plurality of data points included in the first visual representation, which is a closest to a highlighted portion of the first visual representation.

3. The computer-implemented method of claim 2, further comprising highlighting a portion of the second visual representation that corresponds to the highlighted portion of the first visual representation, based on the identified data point of the underlying data of the first visual representation.

4. The computer-implemented method of claim 1, wherein the underlying data of the first visual representation comprises time-series data, and the processing result includes an identification of a time stamp of a data point of the underlying data of the first visual representation.

5. The computer-implemented method of claim 1, wherein the processing result comprises a tree structure analysis result performed by executing the at least one web worker to identify a data point that is closest to a highlighted portion of the first visual representation and a time stamp of data corresponding to the closest point.

6. The computer-implemented method of claim 1, wherein the scheduling further comprises monitoring a load of the plurality of web workers, and adjusting assignments of processing requests among the plurality of web workers to balance the load for the plurality of web workers.

7. The computer-implemented method of claim 1, wherein the first visual representation comprises a chart of a first type, and the second visual representation comprises a chart of a second type that is different than the first type.

8. The computer-implemented method of claim 1, further comprising executing the at least one web worker based on the processing request to obtain the processing result including an identification of the underlying data of the portion of the first visual representation.

9. The computer-implemented method of claim 1, wherein the transferring the identification of the underlying data comprises at least one of:
transferring the identification of the underlying data from a scheduler to the second visual representation, and
transferring the identification of the underlying data from the scheduler to the first visual representation which broadcasts the identification of the underlying data to the second visual representation.

10. A computing system comprising:
a memory storing instructions; and
a processor configured to execute the instructions, wherein the executed instructions cause the processor to:
receive a processing request of a first visual representation displayed on a web page, wherein the processing request includes a request to identify underlying data used to generate a portion of the first visual representation;
schedule the processing request to be performed by a web worker from among a plurality of web workers included in a background;
receive a processing result of the processing request from the at least one web worker, the processing result including an identification of the underlying data of the portion of the first visual representation; and
transfer the identification of the underlying data of the portion of the first visual representation to a second visual representation.

11. The computing system of claim 10, wherein the processing request includes a search request to identify a data point of the underlying data, from among a plurality of data points included in the first visual representation, which is a closest to a highlighted portion of the first visual representation.

12. The computing system of claim 11, wherein the processor is further configured to highlight a portion of the second visual representation that corresponds to the highlighted portion of the first visual representation, based on the identified data point of the underlying data of the first visual representation.

13. The computing system of claim 10, wherein the underlying data of the first visual representation comprises time-series data, and the processing result includes an identification of a time stamp of a data point of the underlying data of the first visual representation.

14. The computing system of claim 10, wherein the processing result comprises a tree structure analysis result performed by executing the at least one web worker to identify a data point that is closest to a highlighted portion of the first visual representation and a time stamp of data corresponding to the closest point.

15. The computing system of claim 10, wherein the processor is further configured to monitor a load of the plurality of web workers, and adjust assignments of processing requests among the plurality of web workers to balance the load for the plurality of web workers.

16. The computing system of claim 10, wherein the first visual representation comprises a chart of a first type, and the second visual representation comprises a chart of a second type that is different than the first type.

17. The computing system of claim 10, wherein the processor is further configured to execute the at least one web worker based on the processing request to obtain the processing result including an identification of the underlying data of the portion of the first visual representation.

18. A non-transitory computer readable medium having stored therein instructions that when executed cause a computer to perform a method comprising:
receiving a processing request of a first visual representation displayed on a web page, wherein the processing request includes a request to identify underlying data used to generate a portion of the first visual representation;
scheduling the processing request to be performed by a web worker from among a plurality of web workers included in a background;
receiving a processing result of the processing request from the at least one web worker, the processing result including an identification of the underlying data of the portion of the first visual representation; and
transferring the identification of the underlying data of the portion of the first visual representation to a second visual representation.

19. The non-transitory computer readable medium of claim 18, wherein the processing request includes a search request to identify a data point of the underlying data, from among a plurality of data points included in the first visual representation, which is a closest to a highlighted portion of the first visual representation.

20. The non-transitory computer readable medium of claim 18, wherein the underlying data of the first visual representation comprises time-series data, and the processing result includes an identification of a time stamp of a data point of the underlying data of the first visual representation.
